(19) United States
(12) Patent Application Publication
(10) Pub. No.: US 2007/0006175 A1
(43) Pub. Date: Jan. 4, 2007

(54) Intra-partitioning of software components within an execution environment

(76) Inventors: David Durham, Beaverton, OR (US); Hormuzd M. Khosravi, Portland, OR (US); Ravi Sahita, Beaverton, OR (US); Uday R. Savagaonkar, Beaverton, OR (US)

Correspondence Address: SCHWABE, WILLIAMSON & WYATT, PACWEST CENTER, SUITE 1900, 1211 S.W. FIFTH AVE., PORTLAND, OR, 97204, US

(21) Appl. No.: 11/395,488

(22) Filed: Mar. 30, 2006

Related U.S. Application Data
(63) Continuation-in-part of application No. 11/173,851, filed on Jun. 30, 2005.
(63) Continuation-in-part of application No. 11/322,669, filed on Dec. 30, 2005.

(51) Int. Cl. G06F 9/44

(52) U.S. Cl. 717/131

(57) ABSTRACT

Embodiments of apparatuses, articles, methods, and systems for intra-partitioning components within an execution environment are generally described herein. Other embodiments may be described and claimed.

### RELATED APPLICATIONS

This application is a continuation-in-part of U.S. patent application Ser. No. 11/173,851, filed on Jun. 30, 2005, and Ser. No. 11/322,669, filed on Dec. 30, 2005, which are both hereby fully incorporated by reference. If any portion of this application should be deemed to contradict any portion of application Ser. Nos. 11/173,851 or 11/322,669, for the purposes of this application, the description provided herein shall control.

### FIELD

Embodiments of the present invention relate generally to the field of computer architecture, and more particularly to intra-partitioning of components within an execution environment of such architectures.

### BACKGROUND

Software programs are subject to complex and evolving attacks by malware seeking to gain control of computer systems. These attacks can take on a variety of different forms ranging from attempts to crash the software program to subversion of the program for alternate purposes. Additionally, programs are subject to operating system failures and bugs within other programs that can cause corruption of unrelated programs running in the same linear address space. Some recent proposals for securing software programs involve creation of multiple execution environments and sequestering protected programs into a protected execution environment. However, this approach typically requires multiple operating systems and may present operating inefficiencies.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a platform to provide intra-partitioning of components within an execution environment, in accordance with an embodiment of the present invention;

FIG. 2 illustrates a platform utilizing parallel execution environments, in accordance with an embodiment of the present invention;

FIG. 3 illustrates operational phases of intra-partitioning of portions of a component, in accordance with an embodiment of the present invention;

FIG. 4 illustrates intra-partitioning of portions of a component in accordance with an embodiment of the present invention;

FIG. 5 illustrates intra-partitioning of portions of a component in accordance with another embodiment of the present invention;

FIG. 6 illustrates intra-partitioning of portions of a component in accordance with an embodiment of the present invention; and

FIGS. 7(a)-(b) illustrate intra-partitioning of portions of a component in accordance with an embodiment of the present invention.

### DETAILED DESCRIPTION

Embodiments of the present invention may provide a method, apparatus, and system for intra-partitioning portions of one or more components within an execution environment on a platform.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A)B” means “(B) or (A and B),” that is, A is optional.

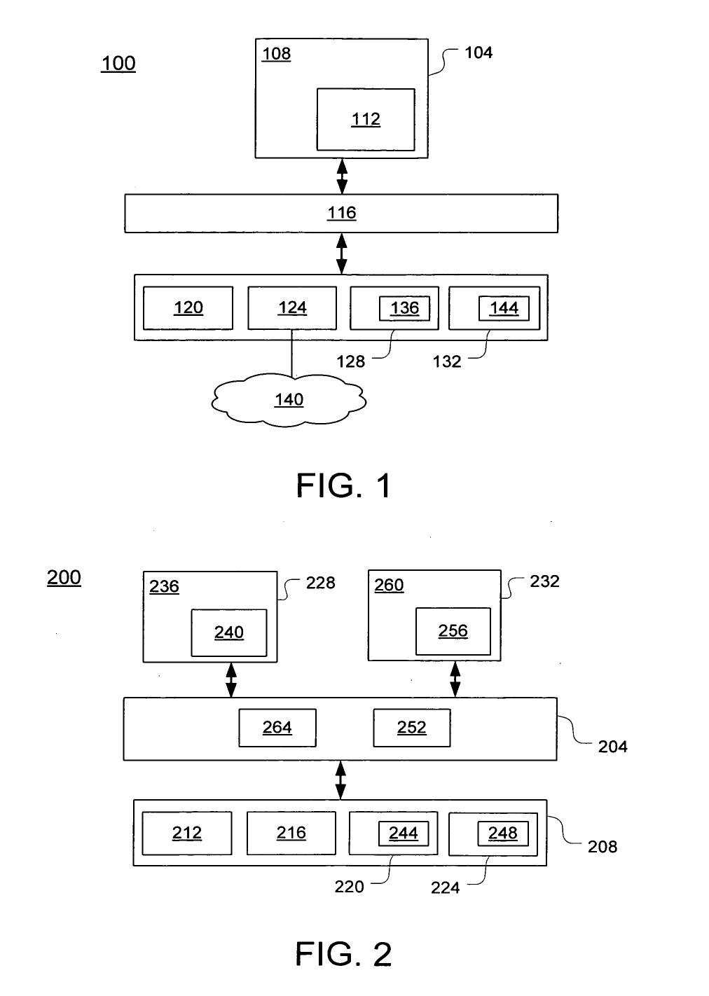

FIG. 1 illustrates a platform 100 to provide for intra-partitioning of portions of a component within an execution environment, in accordance with an embodiment of the present invention. The platform 100 may have an execution environment 104, which may be the domain of an executing operating system (OS) 108. The OS 108 may be a component configured to execute and control general operation of other components within the execution environment 104, such as the software component 112, subject to intra-partition access protections provided to selected components by a management module 116, to be discussed in further detail below.

In some embodiments, the component 112 may be a supervisory-level component, e.g., a kernel component. In various embodiments, a kernel component may be services (e.g., loader, scheduler, memory manager, etc.), extensions/drivers (e.g., for a network card, a universal serial bus (USB) interface, a disk drive, etc.), or a service-driver hybrid (e.g., intrusion detectors to watch execution of code).

As used herein, the term “component” is intended to refer to programming logic and associated data that may be employed to obtain a desired outcome. The term component may be synonymous with “module” or “agent” and may refer to programming logic that may be embodied in hardware or firmware, or in a collection of software instructions, possibly having entry and exit points, written in a programming language, such as, for example, C++, Intel Architecture 32 bit (IA-32) executable code, etc.

A software component may be compiled and linked into an executable program, or installed in a dynamic link library, or may be written in an interpretive language such as BASIC. It will be appreciated that software components may be callable from other components or from themselves, and/or may be invoked in response to detected events or interrupts. Software instructions may be provided in a machine accessible medium, which when accessed, may result in a machine performing operations or executions described in conjunction with components of embodiments of the present invention. Machine accessible medium may be firmware, e.g., an electrically erasable programmable read-only memory (EEPROM), or other recordable/non-recordable medium, e.g., read-only memory (ROM), random access memory (RAM), magnetic disk storage, optical disk storage, etc. It will be further appreciated that hardware components may be comprised of connected logic units, such as gates and flip-flops, and/or may be comprised of programmable units, such as programmable gate arrays or processors. In some embodiments, the components described herein are implemented as software modules, but nonetheless may be represented in hardware or firmware. Furthermore, although only a given number of discrete software/hardware components may be illustrated and/or described, such components may nonetheless be represented by additional components or fewer components without departing from the spirit and scope of embodiments of the invention.

In addition to intra-partitioning selected components of the execution environment 104, the management module 116 may arbitrate general component access to hardware resources such as one or more processor(s) 120, network interface controller 124, storage 128, and/or memory 132.

The processor(s) 120 may execute programming instructions of components of the platform 100. The processor(s) 120 may be single and/or multiple-core processor(s), controller(s), application specific integrated circuit(s) (ASIC(s)), etc.

In an embodiment, storage 128 may represent non-volatile storage to store persistent content to be used for the execution of the components on the platform 100, such as, but not limited to, operating system(s), program files, configuration files, etc. In an embodiment, storage 128 may include stored content 136, which may represent the persistent store of source content for the component 112. The persistent store of source content may include, e.g., executable code store that may have executable files and/or code segments, links to other routines (e.g., a call to a dynamic linked library (DLL)), a data segment, etc.

In various embodiments, storage 128 may include integrated and/or peripheral storage devices, such as, but not limited to, disks and associated drives (e.g., magnetic, optical), universal serial bus (USB) storage devices and associated ports, flash memory, ROM, non-volatile semiconductor devices, etc.

In various embodiments, storage 128 may be a storage resource physically part of the platform 100 or it may be accessible by, but not necessarily a part of, the platform 100. For example, the storage 128 may be accessed by the platform 100 over a network 140 via the network interface controller 124.

Upon a load request, e.g., from a loading agent of the OS 108, the management module 116 and/or the OS 108 may load the stored content 136 from storage 128 into memory 132 as active content 144 for operation of the component 112 in the execution environment 104.

In various embodiments, the memory 132 may be volatile storage to provide active content for operation of components on the platform 100. In various embodiments, the memory 132 may include RAM, dynamic RAM (DRAM), static RAM (SRAM), synchronous DRAM (SDRAM), dual-data rate RAM (DDRRAM), etc.

In some embodiments the memory 132 may organize content stored therein into a number of groups of memory locations. These organizational groups, which may be fixed and/or variable sized, may facilitate virtual memory management. The groups of memory locations may be pages, segments, or a combination thereof.

A virtual memory utilizing paging may facilitate the emulation of a large logical/linear address space with a smaller physical memory page. Therefore, the execution environment 104 may provide a virtual execution environment in which the components may operate, which may then be mapped into physical pages of the memory 132. Page tables maintained by the OS 108 and/or management module 116 may map the logical/linear addresses provided by components of the execution environment 104 to physical address of the memory 132. More details of the implementation of paging, and in particular paging with respect to intra-partitioning of components, may be given below in accordance with embodiments of this invention.

In various embodiments, the component 112, or portions thereof, may be selected for intra-partitioning and the management module 116 may identify and partition off portions of the component 112 to control access by the OS 108 to the component 112. Partitioned portions may include any portion, up to all, of the particular component. A partitioned portion may be sequestered, either physically or virtually, from other components within the same execution environment, such that intra-execution environment accesses may be monitored and restricted, if necessary. Intra-partitioning may facilitate insulation of, e.g., component 112 from the OS 108, without requiring that the component 112 operate in an entirely separate execution environment, with a separate OS. Intra-partitioning may also afford the component 112 a level of protection from other components, even those of similar or higher privilege levels, within the execution environment 104 that may be compromised in some manner, e.g., by malware, critical runtime failures, etc. Embodiments of this invention may provide for this protection while still allowing permitted interactions between the component 112 and other components, e.g., the OS 108, of the execution environment 104. Controlling access by the OS 108 to the component 112 may include various levels of access restrictions as will be discussed below in further detail.

In various embodiments, intra-partitioning of components within an execution environment may be useful in a platform having multiple, execution environments, such as virtual machines operating in a virtualization technology (VT) enabled platform. In such an embodiment, a management module may include, or be a part of, a virtual machine monitor (VMM).

FIG. 2 illustrates a platform 200 utilizing virtualization to provide parallel execution environments in accordance with an embodiment of this invention. In various embodiments, the platform 200 may be similar to, and substantially interchangeable with, the platform 100. Furthermore, elements described below may be similar to, and substantially interchangeable with, like-named elements described above, and vice versa.

In this embodiment a management module, e.g., virtual machine monitor (VMM) 204, on the platform 200 may present multiple abstractions and/or views of the platform hardware 208, e.g., one or more processor(s) 212, network interface controller 216, storage 220, and/or memory 224, to the one or more independently operating execution environments, or “virtual machines (VMs),” e.g., guest VM 228 and auxiliary VM 232. The auxiliary VM 232 may be configured to execute code independently and securely isolated from the guest VM 228 and may prevent components of the guest VM 228 from performing operations that would alter, modify, read, or otherwise affect the components of the auxiliary VM 232. While the platform 200 shows two VMs, other embodiments may employ any number of VMs.

The components operating in the guest VM 228 and auxiliary VM 232 may each operate as if they were running on a dedicated computer rather than a virtual machine. That is, components operating in the guest VM 228 and auxiliary VM 232 may each expect to control various events and have complete access to hardware 208. The VMM 204 may manage VM access to the hardware 208. The VMM 204 may be implemented in software (e.g., as a stand-alone program and/or a component of a host operating system), hardware, firmware, and/or any combination thereof.

The guest VM 228 may include an OS 236 and component 240. Upon a designated event, the VMM 204 may identify and partition off portions of the component 240 to control access to the partitioned portions by the OS 236. In various embodiments, a designated event may be when stored content 244 is loaded from storage 220 to memory 224, as active content 248. However, in various embodiments, other designated events may be additionally/alternatively used.

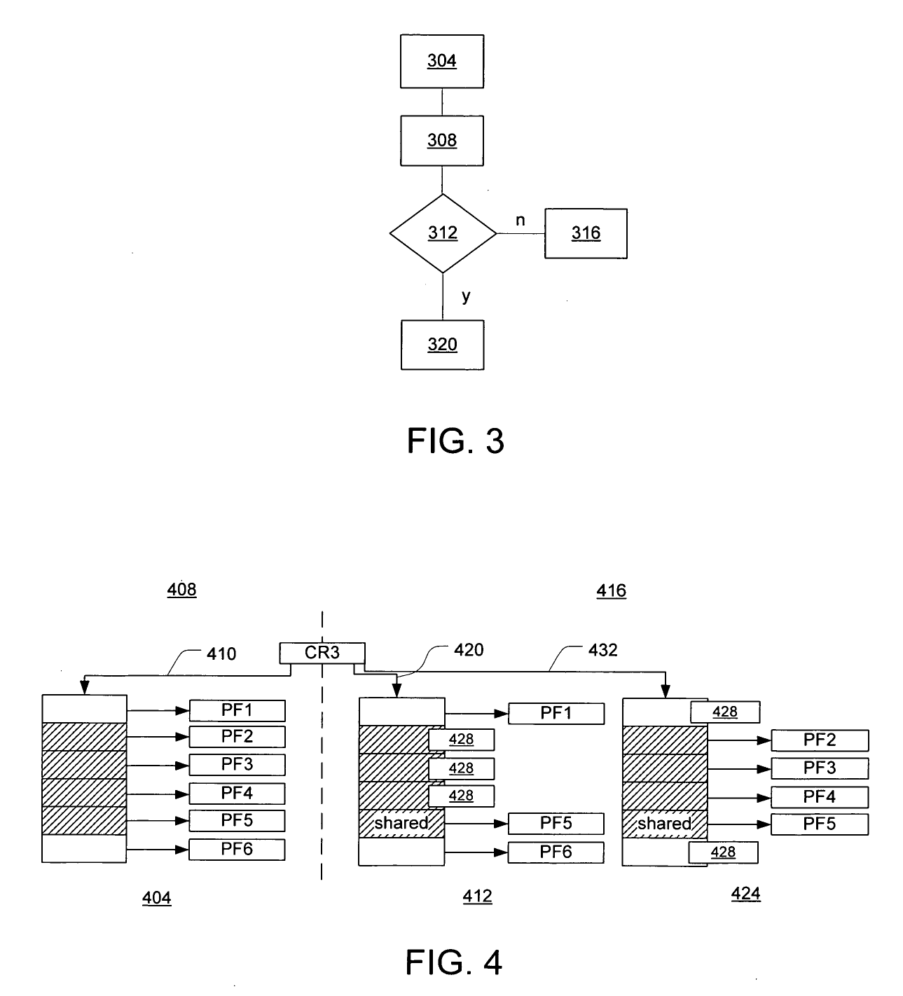

Intra-partition based protections may be provided to component 240 as described in FIG. 3 in accordance with an embodiment of this invention. Operational phases shown in FIG. 3 may be referenced by numerals within parentheses. The component 240 may register with the VMM 204, and more particularly, with an integrity services module (ISM) 252 of the VMM 204 for protection (304). In various embodiments, the registration (304) may take place upon an occurrence of a registration event, e.g., loading of the active content 248 into memory 224, periodically, and/or in some other event-driven manner. In various embodiments, the registration (304) may be initiated by the component 240, another component within the VM 228, e.g., the OS 236, the VMM 204, or a component of the VM 232.

Upon receiving the registration, the ISM 252 may cooperate with an integrity measurement module (IMM) 256 operating in the VM 232 to verify an integrity of the component 112 (308). Verification of the integrity of the component 112 may help to prevent unauthorized modification and/or malicious termination, and may ensure that only recognized components may be afforded protection. The IMM 256 may operate in the VM domain 232 in the context of an OS 260 and may, therefore, be largely independent of OS 236. By running outside of the context of the VM 228 the IMM 256 may have measurement capabilities that are not present, or possibly compromised, in the context of the OS 236.

The IMM 256 may provide the ISM 252 a response to verification request (308) such as pass, fail, pass w/qualification, fail w/qualification, etc. In various embodiments, qualifications may reflect degrees of integrity verification between pass and fail.

In some embodiments, the active content 248 may include an integrity manifest, which may be a collection of information to be used in the verification of the integrity of the component 240. In various embodiments, the integrity manifest may include one or more integrity check values and/or relocation fix-up locations, covering the stored content 244, e.g., code store and/or static and/or configuration settings/data. The IMM 256 may access the integrity manifest from the active content 248 and verify that it corresponds, in total or in part, to an integrity manifest controlled by the IMM 256. A comparison may be done of the images through, e.g., a byte-by-byte analysis or through analysis of cryptographic hashes.

In various embodiments, the IMM 256 may search for the active content 248 directly in the memory 224, e.g., through a direct memory access (DMA). In various embodiments, the linear address of the component 240 may be provided to the IMM 256, e.g., through the ISM 252, and the IMM 256 may perform a virtual-to-physical mapping to identify the locations of the active content 248. In an embodiment, the VMM 204 may provide special interfaces to IMM 256 to provide access to active content 248.

In various embodiments, integrity measurement of the active content 248 may be conducted upon initial registration (304), periodically, and/or in some other event-driven manner while the component 240 is executing. Integrity measurement upon initial registration request may help to determine that the initial state of the active content 248 and/or stored content 244 is as expected based on the state of the content at the time it was manufactured, or loaded last. The periodic or event-driven integrity measurements may help to detect attacks that change the protected attributes of the active content 248 and/or stored content 244.

Further details of integrity measurements of components are described in U.S. patent application Ser. No. 11/173,851, filed Jun. 30, 2005, referred to and incorporated above.

The ISM 252 may receive a response from IMM 256 reflecting verification of integrity of the active content 248 (312). If the verification fails, the ISM 252 may trigger an alert (316). If the verification passes, the ISM 252 may cooperate with a memory manager 264 to intra-partition portions of the component 240 (320).

While FIG. 2 illustrates execution environments being virtual partitions, other embodiments may provide different execution environments through other mechanisms, e.g., using a service processor, and/or an embedded microcontroller. In various embodiments, an auxiliary environment may be partitioned from a host environment via a variety of different types of partitions, including a virtualized partition (e.g., a virtual machine in a Virtualization Technology (VT) scheme), as shown above, and/or an entirely separate hardware partition (e.g., utilizing Active Management Technologies (AMT), “Manageability Engine” (ME), Platform Resource Layer (PRL) using sequestered platform resources, System Management Mode (SMM), and/or other comparable or similar technologies). In various embodiments, a VT platform may also be used to implement AMT, ME, and PRL technologies.

FIG. 4 illustrates intra-partitioning of portions of the component 240 in accordance with an embodiment of this invention. In this embodiment, the OS 236 may create a guest page table (GPT) 404 in an OS domain 408 mapping linear addresses of components executing in the VM 228 to physical addresses, or page frames. Component 240 may be set to occupy the 2^{nd} through 5^{th} page table entries (PTEs), which refer to page frames having active content 248, e.g., PF2-PF5. As is the case in VT platforms, the VMM 204 may monitor and trap register pointer (e.g., CR3) changes. When OS 236 creates GPT 404 and provides a CR3 value 410 pointing to the GPT 404, the VMM 204 may trap on the CR3 change, create an active page table (APT) 412 (which may be a duplicate copy of the GPT 404) in the VMM domain 416, and change the CR3 value 410 to value 420 pointing to the APT 412. In this way, the VMM 204 can coordinate accesses to the memory 224 from a number of VMs, e.g., VM 228 and VM 232.

In this embodiment, the VMM 204 may also create a protected page table (PPT) 424. The VMM 204 may copy the page frames having the active content 248, e.g., PF2-PF5, into the PPT 424 and assign the page table entries (PTEs) that do not refer to those page frames, e.g., 1^{st} PTE and 6^{th} PTE, with access characteristics 428 to cause a page fault upon execution. In various embodiments, the access characteristics 428 may be ‘not present,’ ‘execute disabled,’ and/or read-only. In an embodiment, the access characteristics 428 may be ‘not present’ or a combination of ‘execute disable’ and read-only to prevent unauthorized modifications to the active content 248 from the VM 228. In various embodiments, the setting of the access characteristics 428 may be done by the VMM 204, the component 240, and/or the OS 236.

The VMM 204 may assign the PTEs of the APT 412 that refer to page frames having partitioned portions of the component 240, e.g., 2^{nd} PTE-4^{th} PTE, with access characteristics 428. It may be noted that some page frames, e.g., PF5, may be shared between the partitioned and non-partitioned elements. Therefore, in an embodiment the 5^{th} PTE may not have access characteristics 428 set in either APT 412 or PPT 424.

In this embodiment, execution flow between the APT 412 and PPT 424 may be managed as follows. Initially, CR3 may have value 420 pointing to APT 412. An execution instruction pointer (EIP) may start with the 1^{st} PTE of the APT 412 and, upon an attempted access of the 2^{nd} PTE, may cause a page fault due to the access characteristics 428. The VMM 204 may take control, and change CR3 from value 420 to value 432, pointing to the PPT 424. The EIP may resume operation at the 2^{nd} PTE of the PPT 424, which may be a partitioned element. The EIP may execute through the 3^{rd} PTE, the 4^{th} PTE and the 5^{th} PTE. When the EIP attempts to access the 6^{th} PTE, the access characteristics 428 may cause another page fault and the VMM 204 may switch the CR3 back to value 420, for access to the 6^{th} PTE from the APT 412.

In some embodiments, the VMM 204 may monitor the execution flow between the APT 412 and PPT 424 to verify that the points the EIP enters and/or exits the PPT 424 are as expected. Verification that the EIP jumps into the PPT 424 at valid entry points and/or jumps out of the PPT 424 at valid exit points, could facilitate a determination that the component 240 and/or other components in the VM 228 are operating correctly. If the entry/exit point is not as expected, the VMM 204 may determine that the access attempt to the partitioned component 240 is unauthorized and may raise an exception, which in various embodiments could include rejecting the attempted access, reporting the rejected access attempt to the OS 236 (for example, by injecting an invalid instruction exception) and/or causing a halt of the OS 236 as controlled by the VMM).

In various embodiments, the valid entry and/or exit points may be predetermined, e.g., at the time the component 240 is compiled, and/or may be dynamic. A dynamic entry and/or exit point may be created, e.g., when an interrupt occurs. For example, an interrupt may occur when the EIP is at the 3^{rd} PTE of the PPT 424, the VMM 204 may gain control, verify that the interrupt is authentic, and record the EIP value for use as a dynamic exit point. The dynamic exit point may then serve as a valid entry point upon reentry to the partitioned elements of the PPT 424.

Additionally, in some embodiments an execution state (e.g., a stack state and/or a processor state, e.g., register values) may be recorded at an exit and verified upon reentry. This may provide some assurance that an unauthorized alteration/modification did not occur.

In some embodiments data for an execution state verification may include a copy of the entire state or an integrity check value (ICV) calculation. An ICV may be calculated on, for example, the in parameters of a stack frame by setting the out parameters to default values. Likewise, an ICV may be calculated on the out parameters by setting the in parameters to default values.

If the entry/exit point and/or the execution state verification fail the VMM 204 may issue an exception to the access attempt.

Furthermore, in some embodiments, the VMM 204 may verify that the element calling the partitioned elements, e.g., PF2-PF4, is permitted to access them. For example, the VMM 204 may receive a request from a component to access the partitioned elements. The VMM 204 may identify the component, reference access permissions associated with the partitioned elements, and raise an exception if the access permissions do not permit the identified component to access the partitioned elements.

It may be noted that the page tables shown and described in embodiments of this invention may be simplified for clarity of discussion. In various embodiments of this invention page tables may include multiple levels of indirection and thousands or even millions of entries. Furthermore, in various embodiments entries at different levels may be identified differently than as identified in discussions herein. For example, on an IA-32 platform, the top level may be referred to as a page directory entry (PDE), while the bottom entry may be referred to as a page table entry (PTE). The intra-partitioning discussed herein may be applied to any of these variations/extensions in accordance with embodiments of this invention.

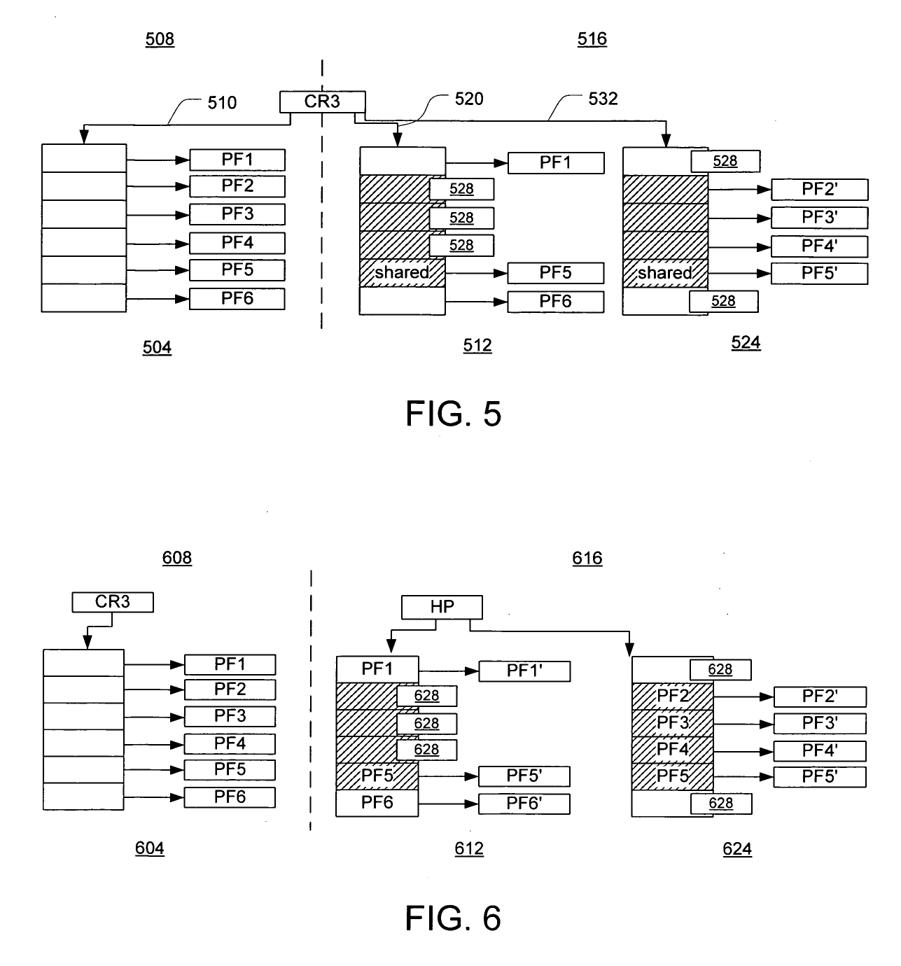

FIG. 5 illustrates intra-partitioning of portions of the component 240 in accordance with another embodiment of this invention. In this embodiment, the OS 236 may create a GPT 504 in an OS domain 508; the VMM 204 may create an APT 512 and a PPT 524 in a VMM domain 516; and execution flow may be managed and monitored among the various page tables in a manner similar to that discussed above with reference to FIG. 4. However, in this embodiment, the VMM 204 may copy the active content 248 from an OS-accessible location in memory 224, e.g., PF2-PF5, to an OS-restricted location in memory 224, e.g., PF2′-PF5′. The OS-restricted location may restrict access of the OS 236 in total or in part. By doing this, the VMM 204 may also restrict unauthorized changes to the active content 248 from components operating in VM 228.

In various embodiments, the OS-restricted locations of the memory 224 may be, for example, on top of the used memory. In various embodiments, the OS-restricted locations may be reserved at boot-up of platform 200 and/or during runtime. The OS-restricted locations may be configured by a basic input/output system (BIOS) and/or the VMM 204.

In this embodiment, access characteristics 528 may not require a read-only designation as any modifications to the active content 248 in the OS-accessible location, e.g., PF2-PF5, may be disregarded.

FIG. 6 illustrates an intra-partitioning of portions of the component 240 in accordance with another embodiment of this invention. In this embodiment, the OS 236 may create a GPT 604 in an OS domain 608 that maps linear addresses used in the VM 228 to OS physical addresses, e.g., PF1-PF6. In this embodiment, however, PF1-PF6 may not refer directly to page frames within the memory 224. That is, the GPT 604 may map guest virtual addresses (GVAs) to host virtual addresses (HVAs) (which may also be referred to as guest physical addresses). The VMM 204 may create a host page table (HPT) 612 in a VMM domain 616 that maps OS physical addresses, e.g., PF1-PF6, to host physical addresses (HPAs), e.g., PF1′-PF6′, which may actually refer to locations of the physical memory 224. The processor may then use the GPT 604 to convert GVA to HVA, and may then use HPT 612 to convert HVA to HPA. Hence, this embodiment may create another layer of paging underneath the layer of paging provided by the OS 236.

The VMM 204 may also create a PPT 624, from which partitioned portions of the component 240 may be accessed. Values of a host pointer (HP) may direct execution from either the HPT 612 or the PPT 624. Execution flow between the HPT 612 and the PPT 624, and protections afforded by monitoring of said execution flow, may be similar to that shown and discussed above with reference to FIG. 4. Access characteristics 628 may facilitate management of execution flow.

In this manner, the VMM 204 may protect the active content 248 in the memory 224 from unauthorized access and/or modification without requiring synchronization of page tables in the OS domain 608 with page tables in the VMM domain 616.

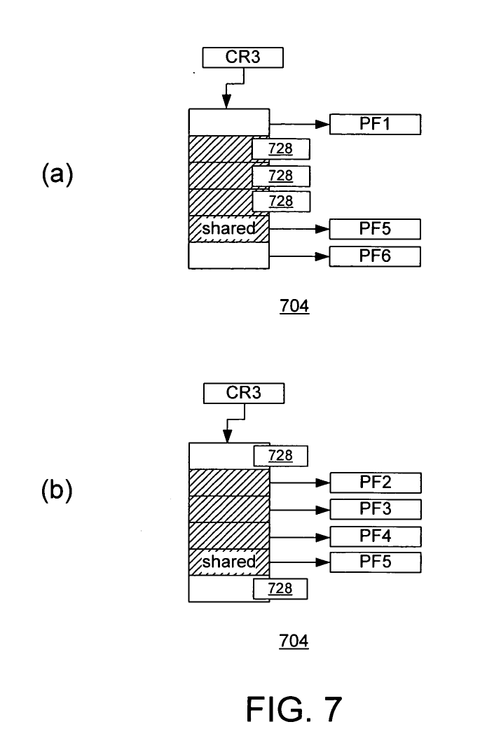

FIGS. 7(a)-(b) illustrate intra-partitioning of portions of the component 240 in accordance with another embodiment of this invention. In this embodiment, the OS 236 may create a GPT 704. The VMM 204 may then set the locations of the memory 224 having the GPT 704 to read-only. As shown in FIG. 7(a), when the OS 236 is operating in the VM 228, the VMM 204 may assign the 2^{nd} PTE-4^{th} PTEs with access characteristics 728 to cause a page fault upon attempted access. When an EIP attempts to access the 2^{nd} PTE, a page fault may occur resulting in a transfer of control to the VMM 204, which may then patch the GPT 704 such that the 1^{st} and 6^{th} PTE have access characteristics 728 and the remaining PTEs do not, as shown in FIG. 7(b). Operation may then resume at the 2^{nd} PTE. In this manner, execution flow out of, and back into the GPT 704, may be monitored in a manner similar to monitoring execution flow between multiple page tables as described above.

Furthermore, with the GPT 704 being read-only, a page fault may occur whenever the OS 236 attempts to write to PF1-PF6. This may allow the VMM 204 to see what the OS 236 is attempting to write to those memory pages and either allow/deny/modify the attempted write based on authority of accessing component.

The VMM 204 monitoring of the GPT 704 may also facilitate, e.g., swapping pages to storage 220. In operation of the platform 200 there may be instances where one or more pages of the active content 248 may be legitimately removed from memory 224 and put back into storage 220, e.g., a disk swap. By looking at the present bits the OS 236 is modifying in the GPT 704, the VMM 204 may recognize an impending disk swap, take a hash value of the active content 248 to be swapped out, and save the hash value in memory 224 accessible to the VMM 204. When the active content 248 is swapped back in, the VMM 204 may compare it to the saved hash value to ensure the active content 248 has not been altered.

In various embodiments, the active content 248 may comprise dynamic data structures in addition to the code image and invariants of the component 240. During execution the component 240 may dynamically allocate pages from the OS 236 (e.g., by invoking a malloc subroutine), which may also be partitioned according to embodiments of this invention.

In some embodiments, partitioning of dynamic data structures may be performed through the OS 236 preallocating an amount of memory 224 considered to be sufficient for needs of the component 240 during runtime. The location and size of the preallocated memory, e.g., data pages, may be communicated to the VMM 204 at registration. The access characteristics of these data pages may also be communicated, or otherwise known, to the VMM 204. For example, in some embodiments, the preallocated memory may be located in an OS-restricted location, e.g., top of used DRAM (TOUD).

In some embodiments, partitioning of dynamic data structures may be performed at a request of the OS 236 during runtime. For example, the OS 236 may notify the VMM 204 every time it allocates a new memory page that is desired to be partitioned. This may be done by registering a reserved ‘call gate’ page that may generate a fault when accessed by the OS 236, and will be known to the VMM 204 as a special page used by the OS 236 to communicate with the VMM 204. Once the OS 236 allocates a page or set of pages, it may access the call gate page to trigger the fault, by writing the page addresses to data structures within the call gate page. Each access to the call gate page may trigger a page fault, causing the VMM 204 to run. When the VMM 204 sees it as a call gate page that was accessed by running the component 240, it may see that values were attempted to be written to the call gate page to determine what it should do next. If the value being written to the page is an address location, then the VMM 204 may partition the newly allocated page table entry. The VMM 204 may also read a command code provided by the component 240 to determine if there is a contiguous range of pages and/or what access characteristics are to be set. The component 240 may change access characteristics, deallocate the added memory page, and/or add more pages at any time by simply writing to the appropriate locations of the preregistered call gate page.

In some embodiments, partitioning of dynamic data structures may be performed at a request of the component 240 independent of the OS 236 during runtime. For example, component 240 may notify the VMM 204 of its intent to protect additional pages by issuing, e.g., a VMexit or other VMCall instruction. The component 240 may also use one of its own pages (allocated when the component 240 was loaded) to implement call gates described above. For example, the VMM 204 may see that a page fault is coming from invalid access to a protected page and interpret it as a call gate invocation. The VMM 204 may then analyze the source of this access and the contents of various registers to determine which additional memory ranges need to be partitioned, and then take appropriate action.

In various embodiments, ownership of a partitioned memory page, e.g., which partitioned component the memory page belongs to, may be changed in similar ways as dynamic data structures are provided for above. As ownership changes, the component transferring ownership may notify the VMM 204 that protections should be applied to another component, should be set to read-only for the other component, and/or simply turned off for the other component.

Embodiments of the present invention shown and described above may facilitate partitioning-off of a component from other components within an execution environment. Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. For example, in an embodiment the APT 412 of FIG. 4 may be modified to be used in a manner similar to how the GPT 704 of FIG. 7 was used, e.g., without using the PPT 424.

Those with skill in the art will readily appreciate that the present invention may be implemented in a very wide variety of embodiments. This description is intended to be regarded as illustrative instead of restrictive on embodiments of the present invention.

What is claimed is:

1. An apparatus comprising:
a component configured to be controlled by an operating system to operate within a first execution environment; and
a management module configured to identify the component and to partition off a portion of the component to control access by the operating system to the portion of the component.

2. The apparatus of claim 1, wherein the management module is further configured to:
create a protected page table and to enable the portion of the component to be operated from the protected page table to control access by the operating system to the portion of the component.

3. The apparatus of claim 2, wherein the management module is further configured to:
create another page table and to enable a portion of the operating system to operate from the another page table.

4. The apparatus of claim 3, wherein the management module is further configured to:
manage the execution flow between the protected page table and the another page table in a manner to control access by the operating system to the portion of the component.

5. The apparatus of claim 4, wherein the management module is further configured to:
manage the execution flow between the protected page table and the another page table based at least in part on one or more expected entry points and/or exit points.

6. The apparatus of claim 5, wherein the management module is further configured to:
compare one or more actual entry points and/or exit points to the one or more expected entry points and/or exit points; and
control access of the operating system to the component based at least in part on the result of said comparison.

7. The apparatus of claim 4, wherein the management module is further configured to:
set access characteristics of page table entries of the protected page table that do not refer to memory having the portion of the component to cause a page fault for an attempted access of one of the not referencing page table entries; and
set access characteristics of page table entries of the another page table that refer to memory having the portion of the component to cause a page fault for an attempted access of one of the referencing page table entries.

8. The apparatus of claim 3, wherein the another page table is an active page table or a host page table.

9. The apparatus of claim 1, wherein the management module comprises a virtual machine monitor.

10. A method comprising:
controlling, by an operating system, operation of a component in a first execution environment;
identifying the component; and
partitioning off a portion of the component to control access by the operating system to the portion of the component.

11. The method of claim 10, wherein content corresponding to the portion of the component is in a memory, the method further comprising:
measuring, from a second execution environment, an integrity of the content.

12. The method of claim 10, wherein said partitioning off the portion of the component comprises:
copying the content from an operating system accessible location in a memory to an operating system restricted location in the memory to control access by the operating system to the portion of the component.

13. The method of claim 10, wherein said partitioning off the portion of the component comprises:
creating a protected page table; and
operating the portion of the component from the protected page table to control access by the operating system to the portion of the component.

14. The method of claim 13, further comprising:
operating a portion of the operating system from another page table; and
managing execution flow between the another page table and the protected page table to control access by the operating system to the portion of the component.

15. The method of claim 14, wherein said managing execution flow comprises:
verifying, upon an entry to the protected page table, an entry point and/or an entering execution state.

16. The method of claim 15, further comprising:
recording, upon an exit from the protected page table, an exit point and/or an exiting execution state;
comparing, upon re-entry to the protected page table, the entry point to the recorded exit point and/or the entering execution state to the recorded exiting execution state; and
verifying the entry point and/or the entering execution state based at least in part on said comparing.

17. The method of claim 10, further comprising:
receiving a request from another component to access the portion of the component;
identifying the another component;
referencing access permissions associated with the portion of the component; and
raising an exception to the requested access based at least in part on the referenced access permissions.

18. A machine accessible medium having associated instructions, which, when accessed, results in a machine:
controlling, by an operating system, operation of a component in a first execution environment;
identifying the component; and
partitioning off a portion of the component to control access by the operating system to the portion.

19. The machine accessible medium of claim 18, wherein the associated instructions, which, when accessed, further results in the machine:
creating a guest page table;
storing the guest page table in a first location in memory; and
setting the first location to read-only.

20. The machine accessible medium of claim 18, wherein the associated instructions, which, when accessed, further results in the machine:
creating a protected page table; and
operating the portion of the component from the protected page table to control access by the operating system to the portion of the component.

21. The machine accessible medium of claim 20, wherein the associated instructions, which, when accessed, further results in the machine:
creating another page table; and
operating a portion of the operating system from the another page table.

22. A system comprising:
a component configured to be controlled by an operating system to operate within a first execution environment;
a management module configured to identify the component and to partition off a portion of the component to control access by the operating system to the portion of the component; and
dynamic random access memory coupled to the management module and having content corresponding to the portion of the component.

23. The system of claim 22, further comprising:
an integrity measurement module configured to operate in a second execution environment and to measure an integrity of the content in the dynamic random access memory.

24. The system of claim 23, wherein the management module is further configured to partition off the portion of the component based at least in part on the measured integrity of the content.

25. The system of claim 22, wherein the management module is further configured to:
copy the content from an operating system accessible location in the dynamic random access memory to an operating system restricted location in the dynamic random access memory to control access by the operating system to the portion of the component.

26. The system of claim 22, wherein the operating system is configured to create and store a guest page table in a first location in the dynamic random access memory.

27. The system of claim 26, wherein the management module is further configured to set the first location to read-only after the operating system has created and stored the guest page table in the first location.
